(19) United States
(12) Patent Application Publication
(10) Pub. No.: US 2018/0154250 A1
(43) Pub. Date: Jun. 7, 2018

(54) BLOCK SCANNING APPARATUS AND METHOD

(71) Applicant: Motionblue INC., Seoul (KR)

(72) Inventors: Je Hoon HONG, Seoul (KR); Na Yeon HONG, Seoul (KR)

(21) Appl. No.: 15/371,581

(22) Filed: Dec. 7, 2016

(30) Foreign Application Priority Data
Dec. 7, 2016 (KR) 10-2016-0166035

(51) Int. Cl. A63F 9/24; H04L 5/00; H04B 5/00

(52) U.S. Cl. CPC A63F 9/24; A63F 2009/2402; H04B 5/0031; H04L 5/0055

(57) ABSTRACT

A block scanning apparatus and method are disclosed. The block scanning apparatus comprises (L×M) block disposition members configured to have an eigen coordinate, wherein a block is disposed in the block disposition members, and a processor configured to scan the (L×M) block disposition members in a unit of K (natural number of above 2) line every predetermined period.

### PRIORITY

This application claims priority under 35 U.S.C. § 119(a) to a Korean patent application filed on Dec. 7, 2016 in the Korean Intellectual Property Office and assigned Serial No. 10-2016-0166035, the entire disclosure of which is incorporated herein by reference.

### TECHNICAL FIELD

The present disclosure relates to a block scanning apparatus and method.

### BACKGROUND ART

A block is a toy which can be laminated, and is a popular toy to children for a long time.

Generally, children make desired shape by disposing horizontally blocks or laminating vertically. Recently, a mirror world service for grating a block in a physical space on a virtual space is catching on.

A patents No. 10-1502270 (title: method and apparatus for providing an educational board game) and No. 10-1502271 (title: method and apparatus for providing a three dimensional digital board game service) of the present applicant disclose a service for providing a board plate and a block, recognizing a block laid on the board plate and displaying a recognized result on a short-distance user terminal.

In the mirror world service, the board plate includes many block disposition members having an eigen coordinate. Accordingly, a CPU of the board plate must scan periodically whether a block is disposed on any block disposition member or whether another block is vertically laminated on the block.

If many block disposition members exist, much time delay occurs for scanning sequentially whole coordinates of the board plate though high price or high specification CPU is used. If a preset scan order exists, a block laid on a specific location may be recognized late, and thus the recognized result may be displayed on a screen after a long time delay.

### SUMMARY

Accordingly, the present invention is provided to substantially obviate one or more problems due to limitations and disadvantages of the related art. One embodiment of the invention provides a block scanning apparatus and method of increasing scan efficiency of a block laid on a board plate with low manufacture cost.

In one aspect, the present invention provides a block scanning apparatus comprising: (L×M) block disposition members configured to have an eigen coordinate, wherein a block is disposed in the block disposition members; and a processor configured to scan the (L×M) block disposition members in a unit of K (natural number of above 2) line every predetermined period.

The processor performs the scanning in a vertical direction of at least two rows or in a horizontal direction of at least two columns at first time.

An access unit connected electrically to a block laid on corresponding block disposition member is provided to the each of the block disposition members.

The access unit may include one or more of a power unit, a data transmission unit, a data receiving unit, an ADC unit or a ground unit.

A plurality of multiplexers are provided among the processor and the access units, N access units are connected to one multiplexer, and the processor controls the multiplexers so that multiplexers determined by switching the multiplexers at a first time transmit/receive data to/from the N access units, respectively.

The multiplexers determined by the switching at each of time are randomly determined.

The block includes: a first block connected to the power unit, the data transmission unit, the data receiving unit and the ground unit; and a second block configured to have resistivity and connected to the power unit, the ADC unit and the ground unit.

The K lines are randomly determined.

In another aspect, the present invention provides a block scanning apparatus including (L×M) block disposition members, where a block is disposed, having an eigen coordinate, the block scanning apparatus comprising: a processor; and a memory connected to the processor, wherein the memory stores program instructions executable by the processor, to scan whether the block is laid on the block disposition members in a unit of K (natural number of above 2) non-sequential lines every predetermined period.

In still another aspect, the present invention provides a method of scanning a block at a board plate including (L×M) block disposition members, where a block is disposed, having an eigen coordinate, the method comprising: (a) generating a scan message in a unit of K (natural number of above 2) non-sequential lines every predetermined period; (b) transmitting the generated scan message to an access unit of block disposition members in the K non-sequential lines; (c) determining whether or not an ACK message about the scan message is received from a block laid on the block disposition member; and (d) transmitting identification information of a block included in the ACK message and an eigen coordinate of a block disposition member for transmitting the ACK message to a user terminal through a network, when the ACK message is received.

In one embodiment of the invention, the block scanning apparatus scans whether a block is laid on the block disposition members, in a unit of non-sequential line every predetermined period, and thus a problem that a block disposed on a specific location is recognized late may be solved.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a system for providing a block game service according to one embodiment of the invention;

FIG. 2 is a perspective view illustrating a board plate according to one embodiment of the invention;

FIG. 3 is a view illustrating internal constitution of the board plate according to one embodiment of the invention;

FIG. 4 is a perspective view illustrating a block according to one embodiment of the invention;

FIG. 5 is a view illustrating internal constitution of a block according to one embodiment of the invention;

FIG. 6 is a view illustrating a modeling block according to one embodiment of the invention;

FIG. 7 is a view illustrating a block scanning process according to one embodiment of the invention;

FIG. 8 is a view illustrating detailed structure of the board plate for scanning the block according to one embodiment of the invention;

FIG. 9 is a view illustrating attribute of the coding block and a graphic object (item on a screen) according to one embodiment of the invention;

FIG. 10 is a view illustrating areas defining the function, the repetition number and the instruction according to the one embodiment of the invention;

FIG. 11 is a view illustrating coding mission information displayed on the screen of the user terminal, and a process of disposing the board plate and coding blocks in a physical space according to the coding mission information;

FIG. 12 is a view illustrating a case that a right coding block and a downward coding block are sequentially disposed in an instruction definition area and an NFC block and a number tag corresponding to number 3 are disposed in a repetition number definition area;

FIG. 13 is a view illustrating a case that the coding blocks are disposed at a leftmost part of the instruction definition area, and a left moving coding block, a right moving coding block, a special action coding block and an upward moving coding block are disposed in an area adjacent to the coding blocks;

FIG. 14 to FIG. 15 are views a coding process using a function block according to one embodiment of the invention; and

FIG. 16 is a view illustrating a user terminal according to one embodiment of the invention.

### DETAILED DESCRIPTION

Example embodiments of the present invention are disclosed herein.

However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Hereinafter, various embodiments of the invention will be described in detail with reference to accompanying drawings.

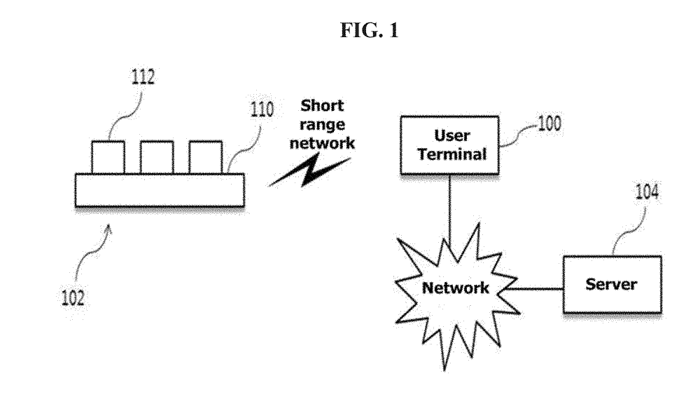

FIG. 1 is a view illustrating a system for providing a block game service according to one embodiment of the invention.

In FIG. 1, the system for providing the block game service of the present embodiment may include a user terminal 100 and a block assembly 102.

The block assembly 102 of the present embodiment may include a board plate 110 and a block 112.

The user terminal 100 is connected to the board plate 110 of the block assembly 102 through a network, and receives information transmitted from the board plate 110.

The user terminal 100 may be a mobile communication terminal including a touch screen or a tablet. However, the user terminal 100 is not limited, but includes every terminal which communicates with the board plate 110 and outputs certain information on a screen.

Preferably, the user terminal 100 and the board plate 110 may be connected through a short range network such as a Bluetooth or a Wi-Fi. However, connection between the user terminal 100 and the board plate 110 is not limited.

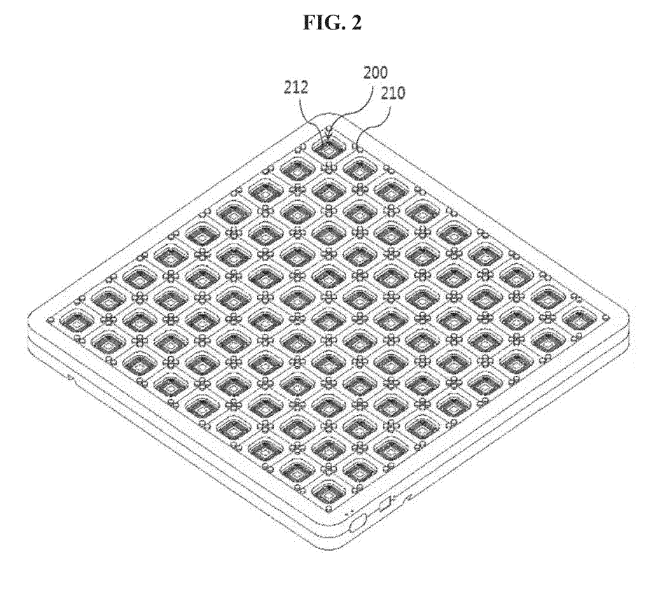

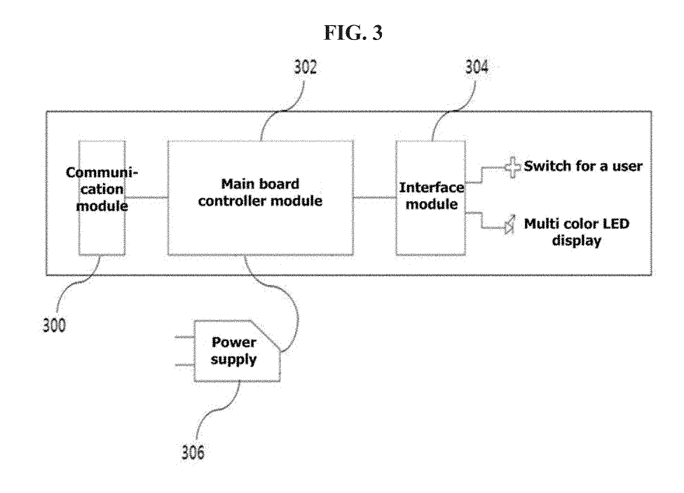

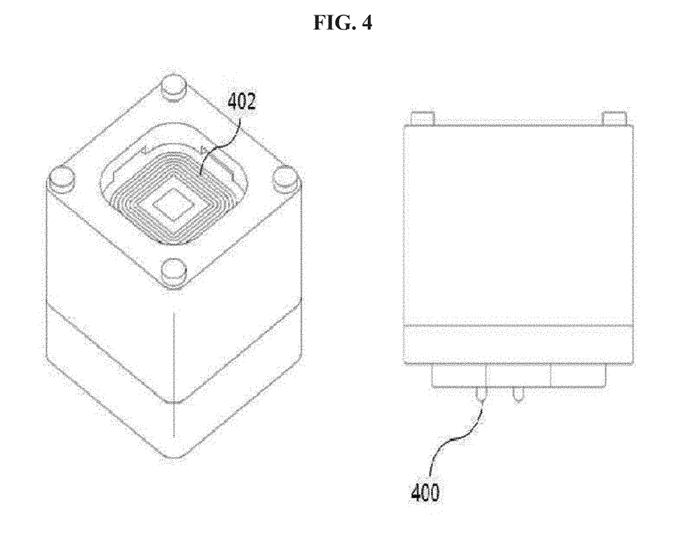

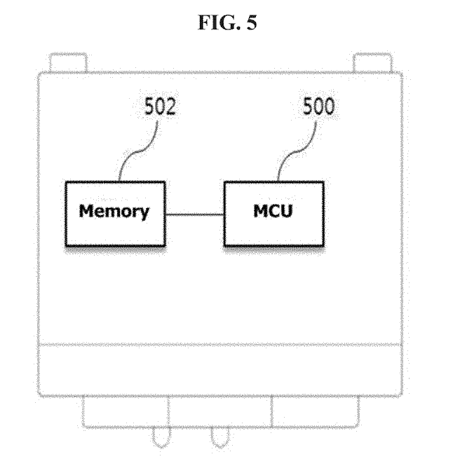

FIG. 2 is a perspective view illustrating a board plate according to one embodiment of the invention, and FIG. 3 is a view illustrating internal constitution of the board plate according to one embodiment of the invention. FIG. 4 is a perspective view illustrating a block according to one embodiment of the invention, and FIG. 5 is a view illustrating internal constitution of a block according to one embodiment of the invention.

In FIG. 2, the board plate 110 of the present embodiment includes a plurality of block disposition members 200.

FIG. 2 shows the board plate 110 including (9×9) block disposition members 200.

However, the board plate 110 may include (7×7) block disposition members 200 or (5×5) block disposition members 200. The structure of the board plate 110 is not limited, and disposition in a horizontal direction may be different from that in a vertical direction.

The board plate 110 scans a block disposed on the block disposition member 200 and then transmits the scanning result to the user terminal 100, and thus it may be defined as a block scanning apparatus.

In present embodiment, the board plate 110 scans a block laid directly on the block disposition member 200 and other blocks laid on the block.

Each of the block disposition members 200 has an eigen coordinate value and has a structure accessible to the block 112.

Particularly, the block disposition member 200 may include a projection member 210 combined with the block 112 and an access unit 212 which supplies a power to the block 112 and transmits or receives data to/from the block 112.

It is desirable that the access unit 212 may be formed with pattern in a certain area of individual block disposition members 200. Here, the pattern of the access unit 212 is electrically connected to corresponding terminal 400 formed on a lower part of the block 112.

Here, the terminal 400 of the block 112 may be formed with a spring pin (pogo pin). A magnet is formed to at least one of the block disposition member 200 or the block 112, and thus the block disposition member 200 and the block 112 may be stably combined.

As shown in FIG. 4, a block disposition member 402, having an access unit which has the same pattern as the access unit 212 of the board plate 110, may be formed on the block 112.

Another block 112 may be laid on the block disposition member 402 of the block 112.

As shown in FIG. 3, the board plate 110 of the present embodiment may include a communication module 300, a main board controller module (hereinafter, referred to as “CPU”) 302, an interface module 304 and a power module 306.

The communication module 300 performs a short range wireless communication (e.g. Bluetooth) with another device (for example, the user terminal 100).

For example, the communication module 300 may be pairing-connected to the user terminal 100 via the short range wireless communication. Since the pairing-connection is well-known by a person in an art, any description concerning the pairing-connection will be omitted.

The communication module 300 transmits location information (i.e. coordinate value) and identification information of a disposed block 112 to the user terminal 100 pairing-connected thereto, according to a control of the CPU 302. The communication module 300 may transmit height information as well as the location information and the identification information of the block 112.

Here, the height information means lamination order information of the blocks 112 when plural blocks 112 are laminated on one block disposition member 200.

The CPU 302 supplies a power to the block 112 when the block 112 is disposed on the board plate 110, and obtains the identification information of corresponding block 112 from a memory 502 of the block 112.

As shown in FIG. 5, the block 112 of the present embodiment may include an MCU 500 and the memory 502 for storing its identification information.

The MCU 500 receives the power when it is electrically connected to the board plate 110 and delivers its identification information stored in the memory 502 to the board plate 110.

In the event that the block 112 is disposed on the board plate 110, the CPU 302 transmits the identification of the block 112 disposed on certain block disposition member 200 and location information (coordinate value) of the block disposition member 200 to the user terminal 100 through the communication module 300.

In one embodiment, the access unit 212 of the board plate 110 may include at least one of a power unit, a data transmission unit, a data receiving unit, an ADC unit (analog-digital converter) or a ground unit (GND).

Here, a power of +5V may be connected to the power unit, and the data transmission unit and the data receiving unit may a UART (universal non-synchronization transceiver) Tx/Rx.

In one embodiment, the other part of the block 112, having a pogo pin as shown in FIG. 4, except the ADC unit is connected to the board plate 110. The board plate 110 recognizes whether any block 112 is disposed on any location via a periodic scanning.

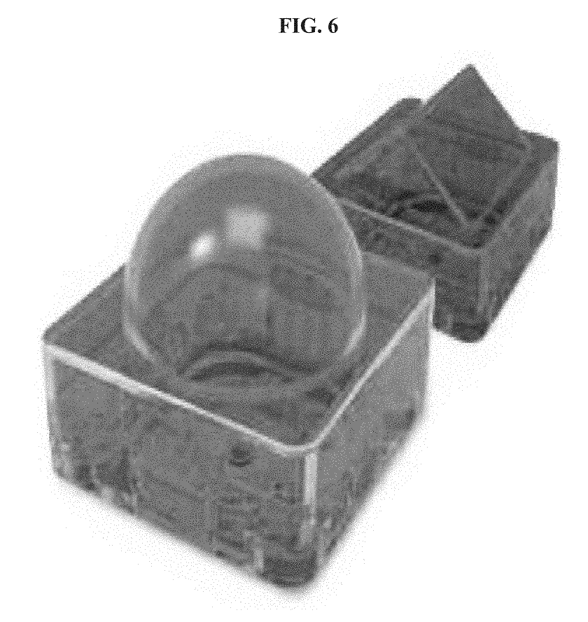

As shown in FIG. 6, a plurality of modeling blocks, on which other block is not laid, of the blocks have resistivity, respectively. The board plate 110 detects whether any modeling block is laid on any location by recognizing the resistivity through the ADC unit.

The modeling block of the present embodiment may express a roof or a vertex of a building, etc. or has various shapes such as a sphere, a circle, a triangle, a pentagon and so on. The modeling blocks may have different colors. Additionally, the modeling block may include an LED, and so it may emit a light.

As described above, the board plate 110 determines whether the block is laminated on any location through the periodic scanning. Hereinafter, a scanning process will be described in detail.

In one embodiment, each of the block disposition members 200 performs data transmitting/receiving (Tx, Rx) and an ADC communication. Hence, (L×M×3) ports are necessary in the event that (L×M) block disposition members 200 is provided on the board plate 110. 243 ports are needed when (9×9) block disposition members are provided as shown in FIG. 2. Accordingly, much time has been required for reading simultaneously data or resistivity of every block disposition member and transmitting simultaneously the read data or resistivity.

If it is assumed that 81 coordinates from (1,1) to (81,81) exist and a scanning is performed from a first coordinate, recognition of a block at a final coordinate must be considerably delayed.

In one embodiment, the CPU 302 scans whether or not the block is laid on the block disposition member in a unit of K (natural number of above 2) non-sequential lines every predetermined period, in (L×M) block disposition members.

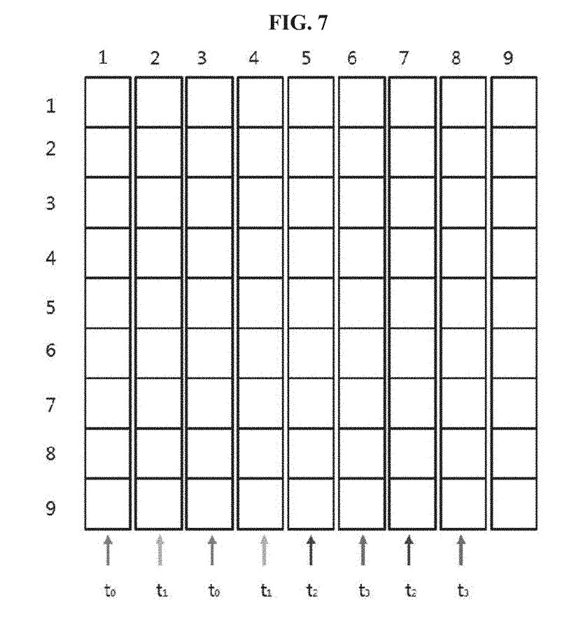

FIG. 7 is a view illustrating a block scanning process according to one embodiment of the invention.

FIG. 7 shows a process of performing vertically a scanning in a unit of two lines, in the (9×9) board plate 110 shown in FIG. 2.

In FIG. 7, the CPU 302 performs sequentially the scanning in a vertical direction (column direction) of 1/3 rows, 2/4 rows, 5/7 rows and 6/8 rows. Here, a ninth row is not included. However, the CPU 302 may perform the scanning about 9/1 rows after the scanning about 6/8 rows is performed.

At next time, a combination of rows scanned simultaneously may differ from previous combination. That is, lines scanned at respective times may be randomly determined.

In above description, two rows are simultaneously scanned, but it is not limited. For example, a scanning may be performed about two columns in a horizontal direction.

In one embodiment, K (natural number of above 2) lines are not preferably in sequence.

This is because a block corresponding to a specific line may be recognized late in the event that consecutive lines are sequentially scanned.

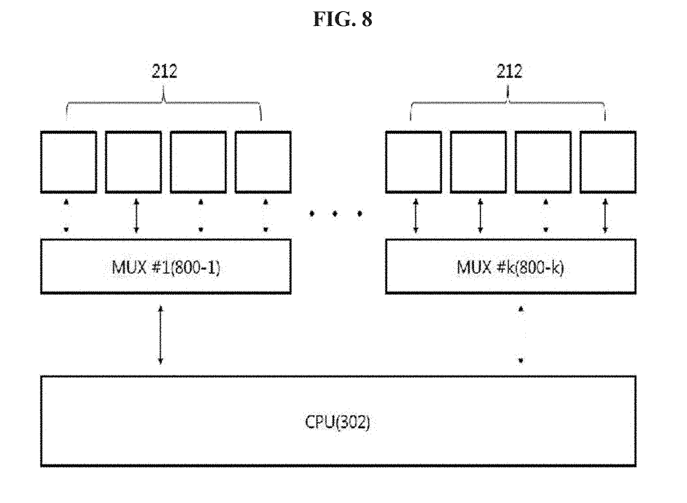

FIG. 8 is a view illustrating detailed structure of the board plate for scanning the block according to one embodiment of the invention.

As shown in FIG. 8, the CPU 302 of the board plate 110 of the present embodiment is connected to the access unit 212 of each of the block disposition members 200 through plural multiplexers (MUX) 800.

The MUX 800 may be connected to one of ports of the CPU 302.

As shown in FIG. 8, one MUX 800 is connected to the access units 212 of the block disposition members 200.

In FIG. 8, the access units 212 of four block disposition members 200 are connected to one MUX 800. However, this is one example and is not limited.

Preferably, the MUX 800 of the present embodiment may be a multiplexer for a UART communication. The MUX for the UART communication is connected to a Tx part and a Rx part of the UART of the access unit 212.

In a scanning process at a first time, the CPU 302 transmits a scan message to one of the MUXs.

A data transmission unit of the block disposition member 200 on which the block is laid transmits the scan message to the block 112. The MCU 500 of the block 112 transmits identification information of the block stored in the memory 502 to the board plate 110, as an ACK message about the scan message.

A data receiving unit of the block disposition member 200 receives the identification information of the block. The MUX transmits the received identification information to the CPU 302.

The above process is similarly applied when another block is disposed on the block.

At a second time, the CPU 302 performs the same process as in the first time through a switching operation and other MUX. The switching operation is repetitively performed in period while a power is supplied to the board plate 110.

In the event that (L×M) block disposition members 200 are provided as shown in FIG. 7, a scanning is performed about M access units 212 in a first row and then it is performed about M access units 212 in a third row, when it is performed in a unit of a line.

Hereinafter, a scanning process when one MUX is not connected to L or M access units in (L×M) board plate 110 will be described.

In another embodiment, one MUX 800 may be connected to an access unit 212 of which the number is smaller than M, according to specification of the MUX 800.

In this case, a scanning may be performed about an access unit 212 except a part of M access units 212 in a row, and a scanning about the other access units may be performed at another time.

It is assumed that plural MUXs 800 are provided among the CPU 302 and the access units 212 and N access units are connected to one MUX.

Here, the CPU 302 of the board plate 110 controls the MUXs 800 so that MUXs (a part of MUXs 800) determined by switching the MUXs 800 at a first time transmits/receives data to/from N access units.

MUXs determined by the switching at respective times may be randomly determined.

In FIG. 7, if four access units 212 are connected to one MUX 800, access units 212 corresponding to columns from a first column to a fourth column of nine access units 212 in each of rows may be connected to one MUX, access units 212 corresponding to columns from a fifth column to an eighth column may be connected to one MUX, and four access units 212 of a final column (a ninth column) in horizontal direction (row direction) may be connected to one MUX. In this case, one access unit 212, i.e. access unit 212 at a final coordinate (9,9) may be directly connected to the CPU 302.

The CPU 302 controls the MUXs 800 so that two MUXs 800 connected to eight access units 212 located in a vertical direction of the first row perform the scanning operation at the first time. Furthermore, the CPU 302 controls the MUXs 800 so that two MUXs 800 connected to eight access units 212 located in the vertical direction of the first row perform the scanning operation.

In one embodiment, the MUXs selected randomly in the vertical direction of respective rows perform the scanning operation, and then two MUXs selected in the horizontal direction of a ninth column may perform the scanning operation.

The MUX 800 may include a MUX for an ADC communication, which is not shown. In this case, the number of the ADC units connected to one MUX is higher than that of the ADC units connected to one MUX for the UART communication.

In one embodiment, a block game service is provided by disposing the block 112 on the board plate 110. Here, the block game service may be a coding education service.

Hereinafter, a process of providing the coding education service through the board plate 110 will be described in detail.

As shown in FIG. 1, the user terminal 100 is connected to the server 104 trough the network, and receives coding mission information.

Here, the network may include a wired/wireless internet or a mobile communication network.

The coding mission information corresponds to a mission to be completed by the user through sequential execution of instructions.

The server 104 transmits a plurality of coding mission information and instructions corresponding to the coding mission information, function information and repetition number information of individual instruction or function, when it receives a coding mission information providing request from the user terminal 100. The server 104 transmits also quiz information, etc. needed for a coding process to the user terminal 100.

The user terminal 100 receives the coding mission information from the server 104 and displays the received coding mission information on a screen.

The server 104 may be a general appstore server. The user terminal 100 may download in advance an application needed for coding education and install the downloaded application.

The downloaded application may include coding mission information according to a level of difficulty and relative information.

The block 112 for providing the coding education service of the present embodiment may include a moving block, a jump block, a pushing block, a crawling block, a rotating block, an extension block, an enlarging block, a reduction block, a flip block, a transparent block and an operation instruction block.

The block 112 may also include an NFC block, a button block, a motor block, a touch block, a switch block, a gear block, a voice recognition block, a function block such as an LED block and a completion block and a color block.

Here, the completion block indicates a block disposed near final coding block after disposing coding blocks according to coding mission.

The user terminal 100 determines whether or not the coding is correctly performed when it receives completion block disposition information from the board plate 110.

Attribute corresponding to respective operations or colors may be set to the operation instruction block and the color block. In another embodiment, the operation instruction block or the color block may be set by accessing electrically a coding card to a block 112 desired by the user or a tag method.

In this time, the MCU 500 of the block 112 recognizes the coding card when the coding card accesses the block 112, and delivers the recognized result to the board plate 110.

Hereinafter, it is assumed that the attribute of the block is determined by using the cording card or by itself for convenience of description, and thus the block will be defined as the coding block.

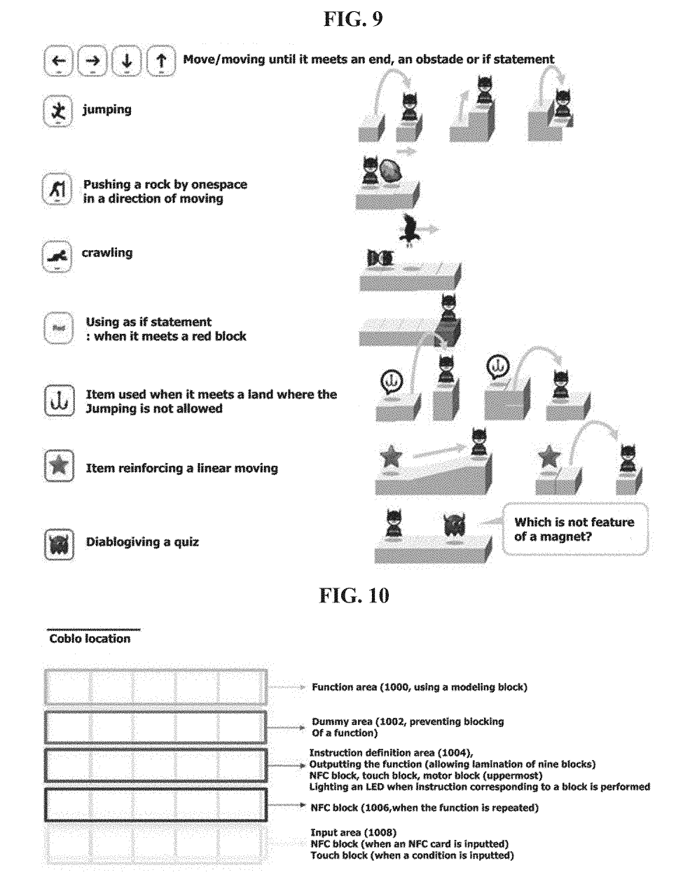

FIG. 9 is a view illustrating attribute of the coding block and a graphic object (item on a screen) according to one embodiment of the invention.

As shown in FIG. 9, the moving coding block is a block for moving a character shown on an imaginary screen in a certain direction. The character moves in the certain direction until it meets an end, an obstacle or an IF statement.

A jump coding block is a block for jumping the obstacle.

The crawling block is a block for crawling under the obstacle.

A red coding block is a block used as IF statement.

A tightrope walking coding block is a block for leaping lands having different height.

A reinforcement coding block is a block for reinforcing a moving of the character on a sloping land.

A quiz item is an item giving a quiz.

In one embodiment, the block game service is provided by disposing the coding blocks on the board plate.

In one embodiment, a first axis for defining a function, a second axis for defining repetition number and a third axis for defining an instruction are set to the board plate 110, so that correct coding about the coding mission information can be achieved, or an education about repetition sentence or function call can be performed.

FIG. 10 is a view illustrating areas defining the function, the repetition number and the instruction according to the one embodiment of the invention.

FIG. 10 shows (5×5) board plate 110

In FIG. 10, (L×M) board plate 110 is divided into a function definition area 1000, a dummy area 1002, an instruction definition area 1004, a repetition number definition area 1006 and an input area 1008 located sequentially in a horizontal or vertical direction from an uppermost part.

The function definition area 1000 is an area where a coding block for defining the function is disposed. One function may be defined by laminating vertically coding blocks and disposing a modeling block on an uppermost coding block. The modeling block recognized by the resistivity is defined as the function block.

In one embodiment, the modeling block having plural shapes is provided. Different functions may be defined by using modeling blocks having different shape.

The dummy area 1002 is an area for separating physically the function definition area 1000 and the instruction definition area 1004.

The instruction definition area 1004 is an area where the coding block for completing the coding mission or the function block is disposed.

The repetition number definition area 1006 is an area for defining a repetition number of a coding block or a function block disposed in the instruction definition area 1004. The repetition number of a certain coding block or a certain function block may be defined by locating an NFC block near the coding block or the function block and laying a tag block on the NFC block.

The input area 1008 means an area in which the NFC block on which an NFC tag for solving a quiz is laid, a touch block for determining one of plural conditions according to a certain condition, etc. locate.

In one embodiment, the board plate 110 detects location of the coding block, the function block, the NFC block or an NFC card, etc. by performing the scanning in a unit of the non-sequential lines when the user lays the coding block, etc. on the board plate 110 according to the coding mission information.

FIG. 11 shows coding mission information 1100 displayed on the screen of the user terminal 100, and a process of disposing the board plate 110 and coding blocks in a physical space according to the coding mission information 1100.

In FIG. 11, a right moving coding block, a downward moving coding block, a right moving coding block and a downward moving coding block are sequentially disposed at a leftmost part of the instruction definition area 1004, and a completion block 1110 is disposed.

In the event that the coding blocks are disposed as shown in FIG. 11, a character moves from a starting point to a position corresponding to disposition of the coding blocks in a routine of coding mission.

However, the character returns to an original position because a final position in accordance with the disposition of the coding blocks is not an end point.

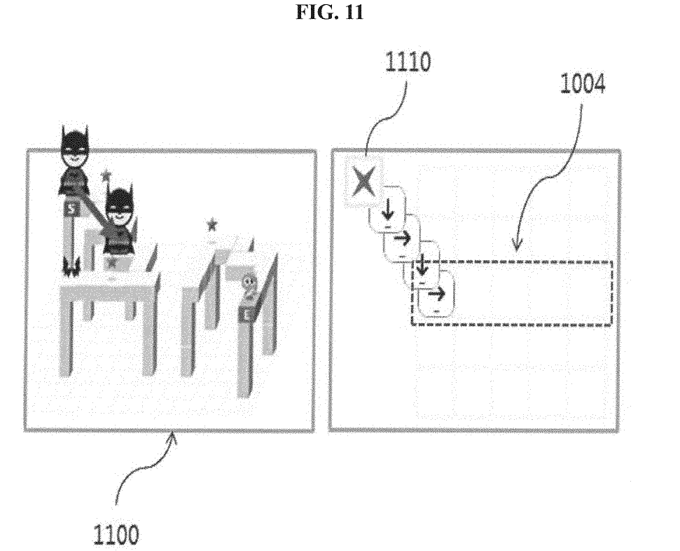

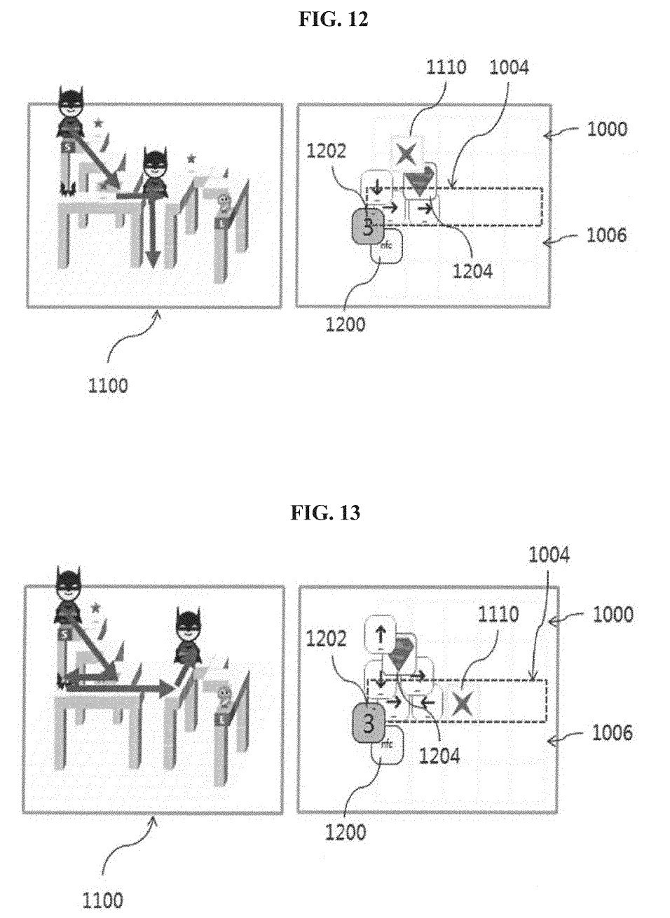

In FIG. 12, a right coding block and a downward coding block are sequentially disposed in the instruction definition area 1004, and an NFC block 1200 and a number tag 1202 corresponding to a number 3 are disposed in the repetition number definition area 1006.

A right coding block corresponding to next execution order, a special action coding block 1204 and the completion block 1110 are adjacently disposed in a right direction of a block for defining the repetition number.

In the event that the coding blocks are disposed as shown in FIG. 12, the character falls when a left moving is performed from a starting point, a downward moving are repeated by three times and then a right moving is performed. As a result, the coding mission is not completed, and thus the character returns to the original position.

A graphic object (wing) should be obtained by performing a left moving after a left moving and a downward moving are performed, so that the character can't be fallen.

In FIG. 13, the coding blocks are disposed at a leftmost part of the instruction definition area 1004 as shown in FIG. 12. A left moving coding block, a right moving coding block, a special action coding block and an upward moving coding block are disposed in an area adjacent to the coding blocks.

Here, the special action coding block 1204 means a block for jumping the character.

In the event that the coding blocks are disposed as shown in FIG. 13, the character may move to another routine by jumping it. However, since the character cannot move up to the end point, it returns to an original position on the user terminal 100.

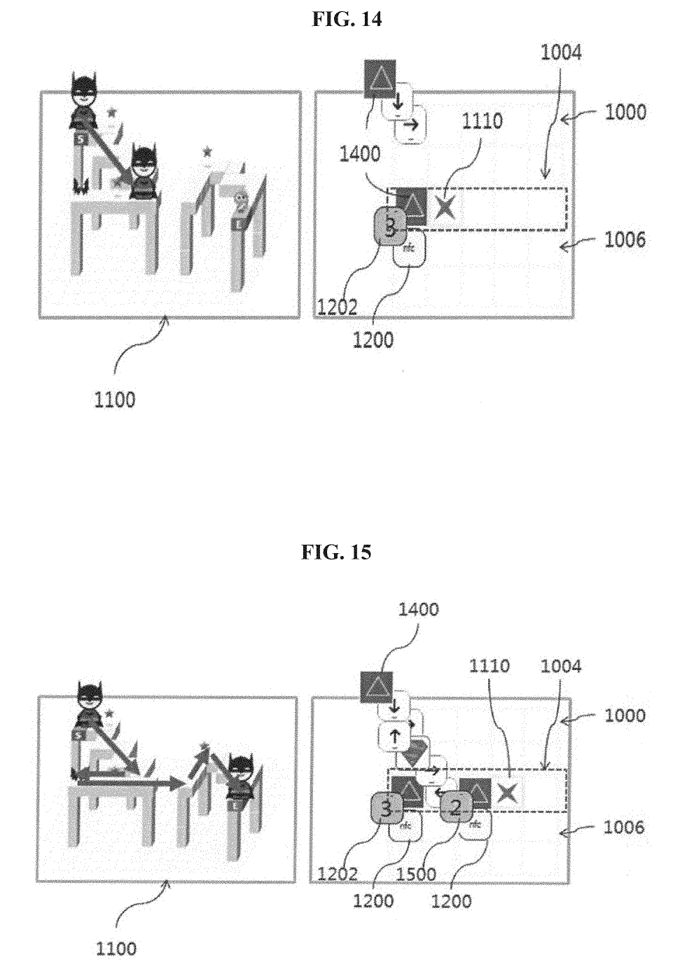

FIG. 14 to FIG. 15 are views a coding process using a function block according to one embodiment of the invention.

In FIG. 14, one function (a first function) may be defined by laminating sequentially a right moving coding block and a downward moving coding block in the function definition area and laminating a function block 1400 having a certain shape on the downward moving coding block.

As shown in FIG. 14, an instruction corresponding to the function is repeatedly performed by three times if the function block 1400 corresponding to the first function is disposed in the instruction definition area 1004 and the NFC block 1200 and the number tag 1202 are disposed adjacent to the function block 1400.

The completion block 1110 is preferably disposed adjacent to the function block 1400 in the instruction definition area 1004 because the function block of the present embodiment is a modeling block on which none block can be laid.

In the event that the coding blocks are disposed as shown in FIG. 14, the character moves until a position just before a position corresponding to jump and moves again to the original position.

Referring to FIG. 15, one function is defined by the coding blocks related to the moving and the function block 1400 having the certain shape, like in FIG. 14.

In FIG. 15, an action corresponding to the first function is repeatedly performed by three times at a starting point, to complete a routine according to the coding mission information.

Subsequently, a wing item is obtained and then a jump corresponding to a special action is performed, and coding blocks for upward straight line moving is disposed adjacent to a first function block.

Next, the first function corresponding to the right moving and the upward moving are repeatedly performed by two times so as to move to the end point.

The first function block is disposed adjacent to a position at which the special action coding block locates, and an NFC block and a number tag 1500 corresponding to number 2 are disposed in the repetition number definition area 1006.

A coding is completed if a completion block is disposed adjacent to the first function block.

In one embodiment, the coding may be completed by laminating vertically the coding blocks related to the moving. However, the coding may be completed through small number of coding blocks by defining the function and the repetition number as shown in FIG. 15.

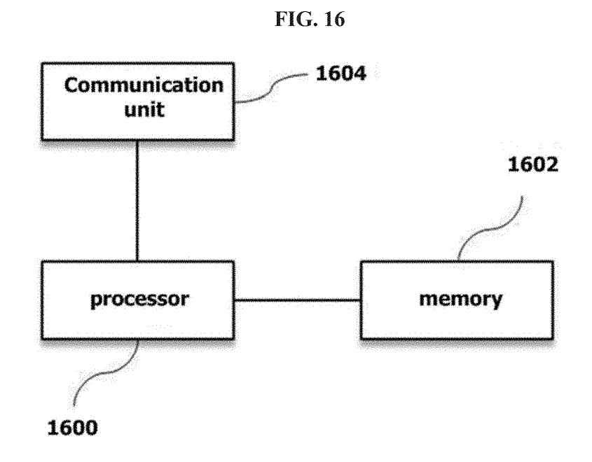

FIG. 16 is a view illustrating a user terminal according to one embodiment of the invention.

As shown in FIG. 16, the user terminal of the present embodiment may include a processor 1600, a memory 1602 and a communication unit 1604.

The processor 1600 may include a central processing unit CPU executable a computer program, an imaginary machine, etc.

The memory 1602 may include a non-volatile storage device such as a fixed hard drive or a removable storage device. The removable storage device may include a compact flash unit, a USB memory stick, etc. The memory 1602 may also include a volatile memory such as a variety of random access memories.

The memory 1602 stores program instructions executable by the processor 1600.

The program instructions recorded on the memory 1602 can be designed and configured specifically for the present invention or can be a type of medium known to and used by the skilled person in the field of computer software. Examples of the program instructions may include not only machine language codes produced by a compiler but also high-level language codes that can be executed by a computer through the use of an interpreter, etc.

The communication unit 1604 communicates with the board plate 110, and receives identification information and location information of the block recognized by performing the scanning in a unit of non-sequential lines through the board plate 110.

In one embodiment, the function definition area, the repetition number definition area, the instruction definition area, etc. are preset in the board plate 110. This means that a coordinate of the block disposition member in respective areas is preset.

The user terminal 100 receives identification information and coordinate information of each of the coding blocks disposed on the board plate 110, and may identify an area in which the coding block is disposed of the areas.

A person having ordinary skill in the art would be able to make various modifications, alterations, and additions without departing from the spirit and scope of the invention, but it is to be appreciated that such modifications, alterations, and additions are encompassed by the scope of claims set forth below.

1. A block scanning apparatus comprising:
(L×M) block disposition members configured to have an eigen coordinate, wherein a block is disposed in the block disposition members; and
a processor configured to scan the (L×M) block disposition members in a unit of K (natural number of above 2) line every predetermined period.

2. The block scanning apparatus of claim 1, wherein the processor performs the scanning in a vertical direction of at least two rows or in a horizontal direction of at least two columns at first time.

3. The block scanning apparatus of claim 1, wherein an access unit connected electrically to a block laid on corresponding block disposition member is provided to the each of the block disposition members.

4. The block scanning apparatus of claim 3, wherein the access unit is includes one or more of a power unit, a data transmission unit, a data receiving unit, an ADC unit or a ground unit.

5. The block scanning apparatus of claim 3, wherein a plurality of multiplexers are provided among the processor and the access units, N access units are connected to one multiplexer, and
the processor controls the multiplexers so that multiplexers determined by switching the multiplexers at a first time transmit/receive data to/from the N access units, respectively.

6. The block scanning apparatus of claim 5, wherein the multiplexers determined by the switching at each of time are randomly determined.

7. The block scanning apparatus of claim 5, wherein the multiplexer includes:
a first multiplexer disposed between a data transmission unit and a data receiving unit and the processor; and
a second multiplexer disposed between an ADC and the processor.

8. The block scanning apparatus of claim 4, wherein the block includes:
a first block connected to the power unit, the data transmission unit, the data receiving unit and the ground unit; and
a second block configured to have resistivity and connected to the power unit, the ADC unit and the ground unit.

9. The block scanning apparatus of claim 1, wherein the K lines are randomly determined.

10. A block scanning apparatus including (L×M) block disposition members, where a block is disposed, having an eigen coordinate, the block scanning apparatus comprising:
a processor; and
a memory connected to the processor,
wherein the memory stores program instructions executable by the processor, to scan whether the block is laid on the block disposition members in a unit of K (natural number of above 2) non-sequential lines every predetermined period.

11. A method of scanning a block at a board plate including (L×M) block disposition members, where a block is disposed, having an eigen coordinate, the method comprising:
(a) generating a scan message in a unit of K (natural number of above 2) non-sequential lines every predetermined period;
(b) transmitting the generated scan message to an access unit of block disposition members in the K non-sequential lines;
(c) determining whether or not an ACK message about the scan message is received from a block laid on the block disposition member; and
(d) transmitting identification information of a block included in the ACK message and an eigen coordinate of a block disposition member for transmitting the ACK message to a user terminal through a network, when the ACK message is received.
